(19) United States
(12) Patent Application Publication
(10) Pub. No.: US 2011/0012347 A1
(43) Pub. Date: Jan. 20, 2011

(54) Threaded Tool Joint Connection

(75) Inventor: Cain Pacheco, Houston, TX (US)

Correspondence Address: Law Offices of Tim Headley, 7941 Katy Fwy, Suite 506, Houston, TX, 77024-1924, US

(73) Assignee: HDD Rotary Sales LLC, Conroe, TX (US)

(21) Appl. No.: 12/502,722

(22) Filed: Jul. 14, 2009

(51) Int. Cl. F16L 25/00

(52) U.S. Cl. 285/333

(57) ABSTRACT

A double shoulder threaded tool joint connection has: a pin with external threads formed between a pin external shoulder and a pin internal shoulder, the pin having a nose section between the internal shoulder and the external threads; and a box with internal threads formed between a box external shoulder and a box internal shoulder. Both the external threads and the internal threads have a thread taper between 0.666 inch per foot and 1.0 inch per foot, and have a stab flank angle and a load flank angle that are equal to about thirty-three degrees.

In another feature of the invention, both the external threads and the internal threads have roots formed in a shape of a portion of a circle.

### CROSS-REFERENCES TO RELATED APPLICATIONS

None

### STATEMENT REGARDING FEDERALLY SPONSORED RESEARCH OR DEVELOPMENT

None.

### REFERENCE TO A “SEQUENCE LISTING,” A TABLE, OR A COMPUTER PROGRAM LISTING APPENDIX SUBMITTED ON A COMPACT DISC AND AN INCORPORATION BY REFERENCE OF THE MATERIAL ON THE COMPACT DISC.

None.

### BACKGROUND OF THE INVENTION

(1) Field of the Invention

The invention relates to threaded tool joint connections.

(2) Description of the related art

U.S. Pat. No. 5,810,401 (“the Mosing patent”) discloses dual mating shoulders and nose faces on the pin and box members (FIG. 5, and Column 6, lines 26-64). However, the Mosing patent does not disclose (a) means for achieving high torque capability with the dual shoulders, (b) means for resistance to bending fatigue by the connection threads, (c) means for reducing stress concentrations in the connection roots, (d) a single large root radius, (e) positive load or stab flank angles, and (f) 90° square mating shoulders.

U.S. Pat. No. 6,030,004 (“the Schock patent”) discloses a double shouldered high torque resistance threaded connection. The tool joint is provided with threads having a 75 degree included angle between the thread flanks, and with generally elliptical root surfaces (FIG. 1, Column 4, lines 1-23, and Column 5, lines 15-49, FIGS. 7 and 9). The Schock patent does not disclose (a) means for enhanced fatigue resistance using a large root surface that is a product of only a single root radius, (b) means for achieving high torque forces with a shallow thread taper, (c) means to achieve a minimal fluid pressure loss and maximum hole cleaning capabilities while maintaining high torque, bending and tensile load resistance, (d) a technique of optimizing high tensile loads while having a large root surface, (e) reduction in connection stiffness to enhance bending strength ratios, and (f) a technique to maintain a balanced ratio between the Abcs/Apcs critical cross sections without increasing the box outer diameter.

U.S. Pat. No. 7,210,710 (“the Williamson patent”) discloses a double shoulder drill stem connection (FIGS. 2 and 3, and Column 9, line 41, to Column 10, line 18). The Williamson patent discloses and discusses a list of patents covering double shoulder tool joints. The Williamson patent is incorporated into this specification by this reference. In discussing its figure number 2, the Williamson patent teaches a thread taper of the box and pin threads of preferably 1 and ⅛ inches per foot. With such a steep taper, the turns-to-make-up are decreased, because the stabbing depth is increased. However, such a steep taper drastically decreases the amount of area that is at the secondary (internal) shoulder, which reduces torque capabilities. Also, with such a steep taper the ID of the connection cannot be as large as shallower taper connections, because there will be a conflict with maintaining enough steel to have an internal shoulder. Finally, such a steep taper does not allow a “slim hole” design, that is, having a small OD and a large ID.

The Williamson patent teaches the use of dissimilar load flanks. Because of that dissimilarity, the Williamson device has to use two or more radii to bridge the two load flanks; thus, as claimed in its claim 7, the roots of the internal and external threads are formed in a shape of a portion of an ellipse.

The Williamson patent also asserts, in discussing its figure number 2, that “the length of the pin nose L.sub.PN should be about one to one and one-half times as long as the counterbore length L.sub.BC.” However, applicant has found that the pin nose length should be as short as possible, because the pin nose acts as a bridge between the pin connection and the box internal shoulder for load distribution. That is, the shorter the length of the pin nose, the more compressive stresses the pin nose can take, thus making a stronger connection.

The Williamson patent does not disclose (a) means for enhanced fatigue resistance using a large root surface that is a product of only a single root radius and (b) means for thread form having equal load and stab flank angles of 33°, which gives optimum surface contact area on the load flanks. The optimum requirements are based on torque, tension, and the ability of a connection not to cross-thread upon extreme axial or bending tensile loads. The Williamson patent also does not disclose (a) a pin nose section length to be at least 60% of that of the box counterbore section to reduce compressive stresses on the pin nose section, (b) any improvement of maintaining a stress concentration factor of below 1.0, (c) reduction in the connection moment of inertia at the connection's critical cross sections to reduce stiff members, and (d) a method of fast connection make-up without the loss of connection torque performance.

Thus, the known prior art has at least two major deficiencies. It lacks: (1) means for enhanced bending fatigue resistance using a large root surface that is a product of only a single root radius, and (2) means to achieve a minimal fluid pressure loss and maximum hole cleaning capabilities while maintaining high torque, bending and tensile load resistance.

In light of the foregoing, a need remains for a tool joint threaded connection that can achieve high torsional strengths, extended fatigue life, high tensile loads and maintain the connection stresses within the material yield strength, all while possessing a connection with small outer diameter and large internal diameter. More particularly, a need still remains for a high-torque, threaded tool joint connection having (a) means to achieve rapid make-up without lose of performance capabilities, (b) means to withstand high cyclic bending stresses without the use of undercut thread forms that reduce the connection's tensile capacity, (c) means to withstand a bending stress at the thread's critical cross section, which bending stress is equal to that which the pipe body itself can withstand.

### BRIEF SUMMARY OF THE INVENTION

A threaded tool joint connection for use in a drill stem assembly comprises: (a) a pin with external threads which are machined between a pin external shoulder and a pin internal shoulder; (b) a box with internal threads which are machined between a box external shoulder and a box internal shoulder; (c) tapered threads designed for high torque, high cyclic fatigue and axial tensile load resistance; and (d) a thread form design that has a large root surface that is a result of a single radius between the load and stab flanks.

In another feature of the invention, the threaded connection has a slim hole profile without sacrificing torsional strength, tensile capacity, connection shear strength, and connection bending strength.

In still other features of the invention, the threaded tool joint connection includes: (a) a thread form that has the ability to withstand torque in order that the shear forces of the threads is at most 70% of the sum of the forces at the external and internal shoulders without the need of a long thread length; (b) a thread form that can maintain a stress concentration factor below 1.0; and (c) a thread form that can withstand bending stresses of 92% to 97% of that of the attached pipe body, (d) a reduction of 13%-41% in the tool joint connection's moment of inertia about the critical cross sections of the pin and box as compared to API connections; and (e) the connection has a “turns-to-make-up” ratio equal to an API connection.

### BRIEF DESCRIPTION OF THE SEVERAL VIEWS OF THE DRAWINGS

FIG. 1 is a cross-section of the two drill pipe sections joined end to end by a tool joint built according to the present invention.

FIG. 2 is an enlarged cross-section of the tool joint of FIG. 1, showing pin and box members made-up, tapered threads, and a thread form according to the present invention.

FIG. 3 is a side profile view of an axial cross-section of the pin of a threaded tool joint connection of the present invention.

FIG. 4 is a close-up of the threads of the pin of FIG. 3.

FIG. 5 is a side profile view of an axial cross-section of the box of a threaded tool joint connection of the present invention.

FIG. 6 is a close-up of the threads of the box of FIG. 5.

### DETAILED DESCRIPTION OF THE INVENTION

In FIG. 1, an upper drill pipe 12 connects to a lower drill pipe 14 by means of a tool joint 16 according to the present invention. The drill pipes 12, 14 have upset portions 18, 20 which have thicker wall thickness for welds 22, 24 at the ends of the drill pipes 12, 14 to the ends of the tool joint 16. The tool joint 16 outer diameter 23 is larger than the outer diameter 25 of the drill pipes 12, 14. The inner diameter 26 of the drill pipes 12, 14, is larger than the inner diameter 28 of the upset portions 18, 20. The inner diameter 28 is substantially the same as the inner diameter 30 near the weld ends of the tool joint 16. The inner diameter 30 of the tool joint is greater than the inner diameter 32 of the section of the tool joint adjacent the threads of the pin 40 and box 42. The pin 40 and the box 42 both taper at seven-eighths of an inch per foot, and have the same centerline 41. Using a taper of less than 1 inch per foot allows the invention to have a large pin nose diameter, which in turns allows for a large contact surface area at the secondary shoulder. This results in the connection being able to withstand higher turning/twisting torques when being screwed together.

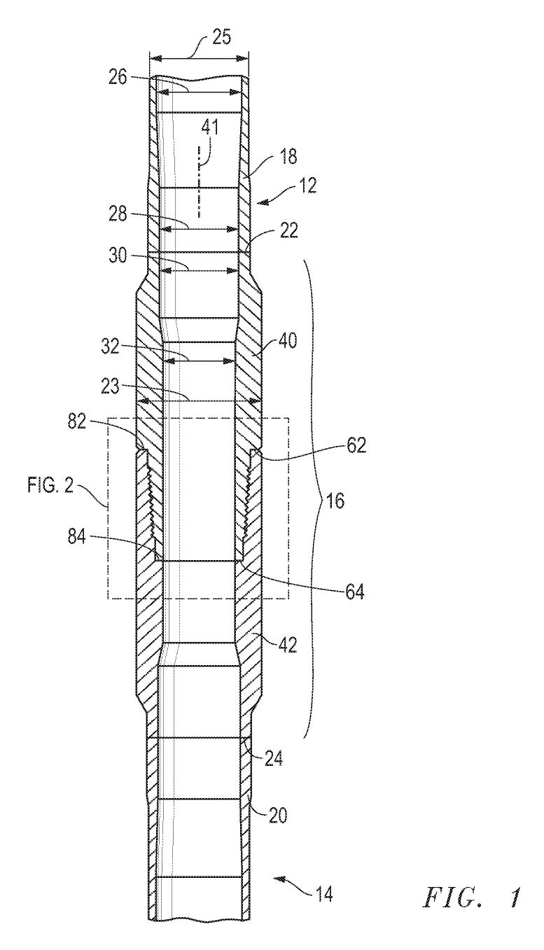

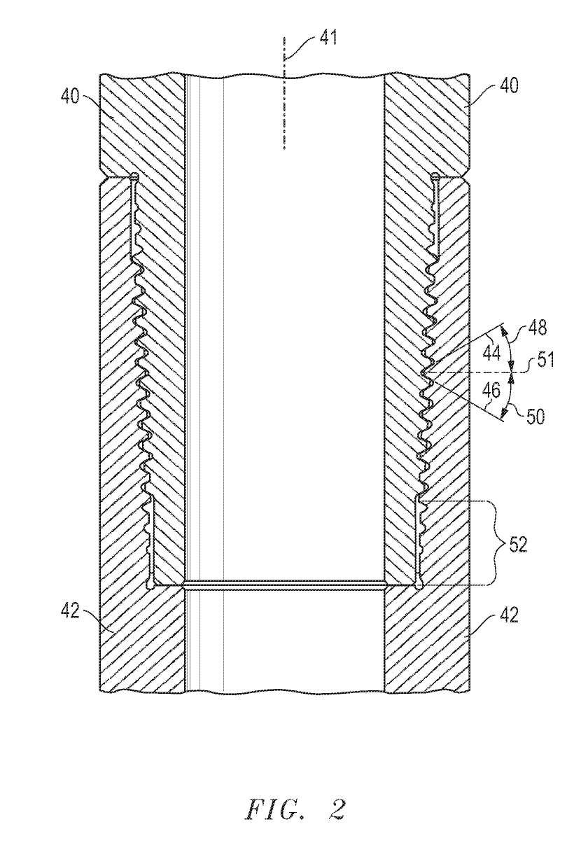

Referring now to FIG. 2, a stab flank 44 and a load flank 46 form an angle made of two equal angles: a stab flank angle 48 of thirty-three degrees, and a load flank angle 50 of thirty-three degrees. A centerline 51 separates the angles 48, 50. A pin nose length 52 is determined by using a ratio of 80% of the material yield strength to be the compressive stress at the pin nose. More precisely, the nose length 52 is calculated by the following formula:

$$Ln = ( \frac{{A}_{n}}{\frac{{F}_{n}}{( {D}_{totm} - internal . shoulder . gap )}} ) * S M Y S$$

where Dₜₒₜₘ is sum of the deflection of pin base and box counterbore sections, An=cross sectional area of the nose, Fn=force on the nose, and SMYS is a specified material yield strength.

The sum of the forces of both shoulders is equal to 0.70 times the thread shear forces. This safety factor of 1.3 allows for the Lpc (length of the pin connection) to be stronger in shear than the axial forces created by both shoulders combined. The formula for thread shear force (Thd_{sf}) is:

$${Thd}_{s f} = .577 * S M Y S * π * ( \frac{L p c}{2} ) * {D}_{t} ,$$

where

$${D}_{t} = P . D . - taper * \frac{L p c}{24}$$

and where P.D.=thread pitch diameter.

Referring now to FIG. 3, the pin 40 has a thread 60, which has a pitch of three threads per inch. The pin 40 has a primary (also called external) shoulder 62. The primary shoulder 62 functions as the primary make-up surface for the tool joint 16. The pin 40 also has a secondary (also called an internal) shoulder 64. The secondary shoulder 64 offers added surface area along with a mechanical stop. The added surface area gives greater torsional strength in the connection.

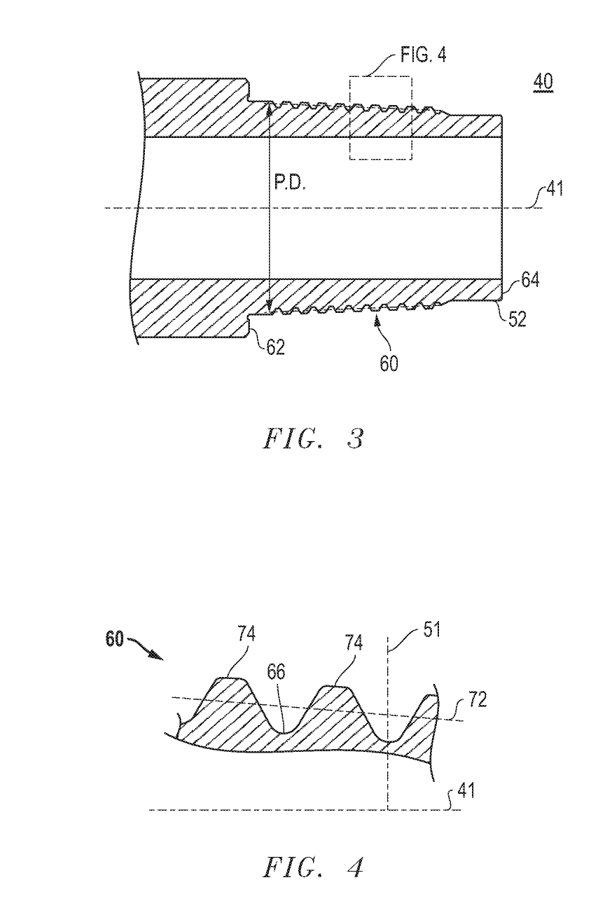

Referring now to FIG. 4, the thread 60 of the pin 40 has a single root radius 66 equal to 0.063 inch. (For larger connection sizes, a larger root radius, such as 0.070″ and 0.105″ is used.) The large root radius 66 allows the root of the thread 60 to withstand greater bending stresses at the tool joint's critical cross sections, thus resulting in greater resistance to metal fatigue. The large root radius 66 also provides the tool joint 16 with higher tensile load capabilities. The centerline 51 of the root radius 66 is perpendicular to the centerline 41.

The tops of the thread crests 74 of the thread 60 are aligned parallel to the pitch diameter line 72. The pitch diameter line is an imaginary line that runs the length of the thread and divides the thread in half between the thread crest and the thread root. Radii on the thread crests 74 are used to remove any sharp corner edges of the thread form to keep the connection from galling.

Referring now to FIG. 5, the box 42 has a thread 80, which has a pitch of three threads per inch. The box 42 has a primary (also called external) shoulder 82. The primary shoulder 82 functions as the primary make-up surface for the tool joint 16. The box 42 also has a secondary (also called an internal) shoulder 84. The secondary shoulder 84 offers added surface area along with a mechanical stop. The added surface area gives greater torsional strength in the connection.

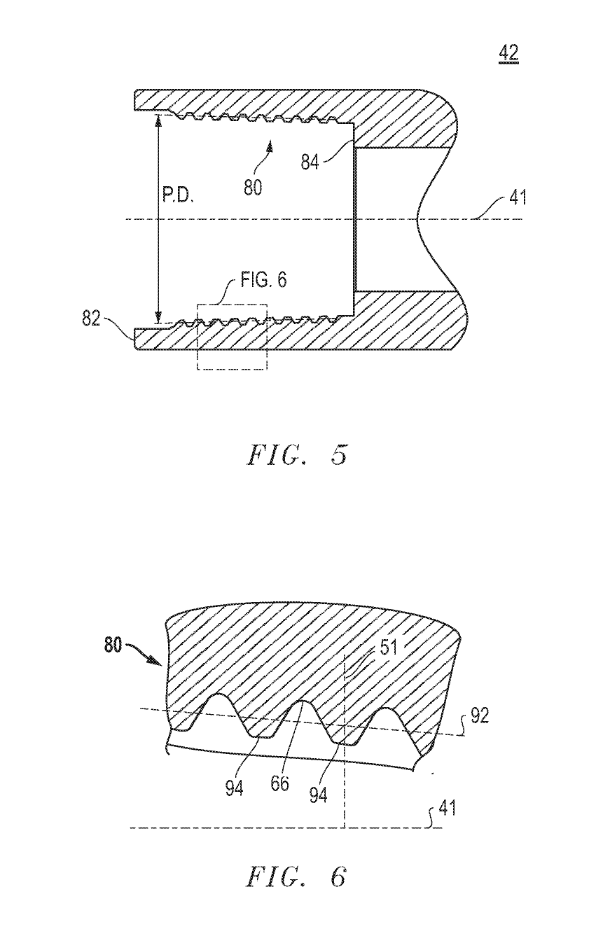

Referring now to FIG. 6, the thread 80 of the box 42 has a single root radius 66 equal to 0.063 inch. (For larger connection sizes, a larger root radius, such as 0.070″ and 0.105″ is used.) The large root radius 66 allows the root of the thread 60 to withstand greater bending stresses at the tool joint's critical cross sections, thus resulting in greater resistance to metal fatigue. The large root radius 66 also provides the tool joint 16 with higher tensile load capabilities. The centerline 51 of the root radius 66 is perpendicular to the centerline 41.

The tops of the thread crests 94 of the thread 80 are aligned parallel to the pitch diameter line 92. The pitch diameter line is an imaginary line that runs the length of the thread and divides the thread in half between the thread crest and the thread root. Radii on the thread crests 94 are used to remove any sharp corner edges of the thread form to keep the connection from galling.

Referring again to FIG.1, the pin 40 and the box 42 connect with a primary seal formed by the pin external shoulder 62 forced against the box external shoulder 82, and a secondary seal formed by the pin internal shoulder 64 forced against the box internal shoulder 84.

1. A double shoulder threaded tool joint connection (16) for use in a drill stem comprising:
a. a pin (40) with external threads (60) formed between a pin external shoulder (62) and a pin internal shoulder (64), the pin (40) having a nose section (52) between the internal shoulder (64) and the external threads (60);
b. a box (42) with internal threads (80) formed between a box external shoulder (82) and a box internal shoulder (84);
wherein the internal threads (80) and the external threads (60) are arranged and designed for connection with each other so that the box (42) and the pin (40) are connected with a common center-line and with a primary seal formed by the pin external shoulder (62) forced against the box external shoulder (82) and a secondary seal formed by the pin internal shoulder (64) forced against the box internal shoulder (84), and wherein the joint connection (16) is characterized by both the external threads (60) and the internal threads (80):
a. having a thread taper between 0.666 inch per foot and 1.0 inch per foot;
b. having a stab flank angle and a load flank angle that are equal to about thirty-three degrees; and
c. having roots formed in a shape of a portion of a circle.

2. The connection of claim 1, wherein the external threads (60) and the internal threads (80) have a thread taper of approximately 0.875 inch per foot.

3. The connection of claim 1, wherein the length of the nose section (52) is calculated by the following formula:
$$Ln = ( \frac{{A}_{n}}{\frac{{F}_{n}}{( {D}_{totm} - internal . shoulder . gap )}} ) * S M Y S$$
where Dₜₒₜₘ is sum of the deflection of pin base and box counterbore sections, An=cross sectional area of the nose,
Fn=force on the nose, and SMYS is a specified material yield strength.

4. The connection of claim 1, wherein the thread shear force (Thd_{sf}) is calculated by the following formula:
$${Thd}_{s f} = .577 * S M Y S * π * ( \frac{L p c}{2} ) * {D}_{t} , where {D}_{t} = P . D . - taper * \frac{L p c}{24} ,$$
SMYS=a specified material yield strength, and P.D.=thread pitch diameter.

5. A double shoulder threaded tool joint connection (16) for use in a drill stem comprising:
a. a pin (40) with external threads (60) formed between a pin external shoulder (62) and a pin internal shoulder (64), the pin (40) having a nose section (52) between the internal shoulder (64) and the external threads (60);
b. a box (42) with internal threads (80) formed between a box external shoulder (82) and a box internal shoulder (84);
wherein the internal threads (80) and the external threads (60) are arranged and designed for connection with each other so that the box (42) and the pin (40) are connected with a common center-line and with a primary seal formed by the pin external shoulder (62) forced against the box external shoulder (82) and a secondary seal formed by the pin internal shoulder (64) forced against the box internal shoulder (84), and wherein the joint connection (16) is characterized by both the external threads (60) and the internal threads (80):
a. having a thread taper between 0.75 inch per foot and 0.95 inch per foot;
b. having a stab flank angle and a load flank angle that are equal to about thirty-three degrees; and
c. having roots formed in a shape of a portion of a circle.

6. The connection of claim 5, wherein the external threads (60) and the internal threads (80) have a thread taper of approximately 0.875 inch per foot.

7. The connection of claim 5, wherein the length of the nose section (52) is calculated by the following formula:
$$Ln = ( \frac{{A}_{n}}{\frac{{F}_{n}}{( {D}_{totm} - internal . shoulder . gap )}} ) * S M Y S$$
where Dₜₒₜₘ is sum of the deflection of pin base and box counterbore sections, An=cross sectional area of the nose,
Fn=force on the nose, and SMYS is a specified material yield strength.

8. The connection of claim 5, wherein the thread shear force (Thd_{sf}) is calculated by the following formula:
$${Thd}_{s f} = .577 * S M Y S * π * ( \frac{L p c}{2} ) * {D}_{t} , where {D}_{t} = P . D . - taper * \frac{L p c}{24} ,$$
SMYS=a specified material yield strength, and P.D.=thread pitch diameter.

9. A double shoulder threaded tool joint connection (16) for use in a drill stem comprising:
a. a pin (40) with external threads (60) formed between a pin external shoulder (62) and a pin internal shoulder (64), the pin (40) having a nose section (52) between the internal shoulder (64) and the external threads (60);
b. a box (42) with internal threads (80) formed between a box external shoulder (82) and a box internal shoulder (84);
wherein the internal threads (80) and the external threads (60):
a. are arranged and designed for connection with each other so that the box (42) and the pin (40) are connected with a common center-line and with a primary seal formed by the pin external shoulder (62) forced against the box external shoulder (82) and a secondary seal formed by the pin internal shoulder (64) forced against the box internal shoulder (84);
b. have a thread taper of approximately 0.875 inch per foot;
c. have a stab flank angle and a load flank angle that are equal to about thirty-three degrees; and
d. have roots formed in a shape of a portion of a circle, and
wherein the length of the nose section (52) is calculated by the following formula:
$$Ln = ( \frac{{A}_{n}}{\frac{{F}_{n}}{( {D}_{totm} - internal . shoulder . gap )}} ) * S M Y S$$
where Dₜₒₜₘ is sum of the deflection of pin base and box counterbore sections, An=cross sectional area of the nose,
Fn=force on the nose, and SMYS is a specified material yield strength, and wherein the thread shear force (Thd_{sf}) is calculated by the following formula:
$${Thd}_{s f} = .577 * S M Y S * π * ( \frac{Lpc}{2} ) * {D}_{t} , where {D}_{t} = P . D . - taper * \frac{Lpc}{24} ,$$
SMYS=a specified material yield strength, and P.D.=thread pitch diameter.
